(19) United States
(12) Patent Application Publication
(10) Pub. No.: US 2014/0290478 A1
(43) Pub. Date: Oct. 2, 2014

(54) HIGH PERFORMANCE CROSS-LINKED POLYIMIDE ASYMMETRIC FLAT SHEET MEMBRANES

(71) Applicant: UOP LLC, DesPlaines, IL (US)

(72) Inventors: Chunqing Liu, Arlington Heights, IL (US); Zara Osman, Glenview, IL (US); Howie Q. Tran, Skokie, IL (US); Angela N. Troxell, Chicago, IL (US)

(73) Assignee: UOP LLC, Des Plaines, IL (US)

(21) Appl. No.: 13/851,169

(22) Filed: Mar. 27, 2013

(51) Int. Cl. B01D 71/64; B01D 61/36; B01D 53/22

(52) U.S. Cl. CPC B01D 71/64; B01D 53/228; B01D 61/362
USPC 95/47; 96/13; 95/45; 95/50; 95/49; 95/51; 95/54; 95/55; 95/53; 95/52; 210/640

(57) ABSTRACT

The present invention discloses high performance cross-linked polyimide asymmetric flat sheet membranes and a process of using such membranes. The cross-linked polyimide asymmetric flat sheet membranes have shown CO₂ permeance higher than 80 GPU and CO₂/CH₄ selectivity higher than 20 at 50° C. under 6996 kPa of a feed gas with 10% CO₂ and 90% CH₄ for CO₂/CH₄ separation.

### BACKGROUND OF THE INVENTION

This invention relates to high performance cross-linked polyimide asymmetric flat sheet membranes and methods for making and using these membranes.

In the past 30-35 years, the state of the art of polymer membrane-based gas separation processes has evolved rapidly. Membrane-based technologies have advantages of both low capital cost and high-energy efficiency compared to conventional separation methods. Membrane gas separation is of special interest to petroleum producers and refiners, chemical companies, and industrial gas suppliers. Several applications of membrane gas separation have achieved commercial success, including N₂ enrichment from air, carbon dioxide removal from natural gas and from enhanced oil recovery, and also in hydrogen removal from nitrogen, methane, and argon in ammonia purge gas streams. For example, UOP's Separex™ cellulose acetate spiral wound polymeric membrane is currently an international market leader for carbon dioxide removal from natural gas.

Polymers provide a range of properties including low cost, permeability, mechanical stability, and ease of proccessability that are important for gas separation. Glassy polymers (i.e., polymers at temperatures below their T_{g}) have stiffer polymer backbones and therefore let smaller molecules such as hydrogen and helium pass through more quickly, while larger molecules such as hydrocarbons pass through more slowly as compared to polymers with less stiff backbones. Cellulose acetate (CA) glassy polymer membranes are used extensively in gas separation. Currently, such CA membranes are used for natural gas upgrading, including the removal of carbon dioxide. Although CA membranes have many advantages, they are limited in a number of properties including selectivity, permeability, and in chemical, thermal, and mechanical stability.

The membranes most commonly used in commercial gas and liquid separation applications are asymmetric polymeric membranes and have a thin nonporous selective skin layer that performs the separation. Separation is based on a solution-diffusion mechanism. This mechanism involves molecular-scale interactions of the permeating gas with the membrane polymer. The mechanism assumes that in a membrane having two opposing surfaces, each component is sorbed by the membrane at one surface, transported by a gas concentration gradient, and desorbed at the opposing surface. According to this solution-diffusion model, the membrane performance in separating a given pair of gases (e.g., CO₂/CH₄, O₂/N₂, H₂/CH₄) is determined by two parameters: the permeability coefficient (abbreviated hereinafter as permeability or P_{A}) and the selectivity (α_{A/B}). The P_{A} is the product of the gas flux and the selective skin layer thickness of the membrane, divided by the pressure difference across the membrane. The α_{A/B} is the ratio of the permeability coefficients of the two gases (α_{A/B}=P_{A}/P_{B}) where P_{A} is the permeability of the more permeable gas and P_{B} is the permeability of the less permeable gas. Gases can have high permeability coefficients because of a high solubility coefficient, a high diffusion coefficient, or because both coefficients are high. In general, the diffusion coefficient decreases while the solubility coefficient increases with an increase in the molecular size of the gas. In high performance polymer membranes, both high permeability and selectivity are desirable because higher permeability decreases the size of the membrane area required to treat a given volume of gas, thereby decreasing capital cost of membrane units, and because higher selectivity results in a higher purity product gas.

One of the components to be separated by a membrane must have a sufficiently high permeance at the preferred conditions or an extraordinarily large membrane surface area is required to allow separation of large amounts of gases or liquids. Permeance, measured in Gas Permeation Units (GPU, 1 GPU=10−⁶ cm³ (STP)/cm² s (cm Hg)), is the pressure normalized flux and is equal to permeability divided by the skin layer thickness of the membrane. Commercially available gas separation polymer membranes, such as CA, polyimide, and polysulfone membranes formed by phase inversion and solvent exchange methods have an asymmetric integrally skinned membrane structure. Such membranes are characterized by a thin, dense, selectively semipermeable surface “skin” and a less dense void-containing (or porous), non-selective support region, with pore sizes ranging from large in the support region to very small proximate to the “skin”. However, fabrication of defect-free high selectivity asymmetric integrally skinned polyimide membranes is difficult. The presence of nanopores or defects in the skin layer reduces the membrane selectivity. The high shrinkage of the polyimide membrane on cloth substrate during membrane casting and drying process results in unsuccessful fabrication of asymmetric integrally skinned polyimide flat sheet membranes using phase inversion technique.

In order to combine high selectivity and high permeability together with high thermal stability, new high-performance polymers such as polyimides (PIs), poly(trimethylsilylpropyne) (PTMSP), and polytriazole were developed. These new polymeric membrane materials have shown promising properties for separation of gas pairs like CO₂/CH₄, O₂/N₂, H₂/CH₄, and C₃H₆/C₃H₈. However, current polymeric membrane materials have reached a limit in their productivity-selectivity trade-off relationship. In addition, gas separation processes based on glassy polymer membranes frequently suffer from plasticization of the stiff polymer matrix by the sorbed penetrating molecules such as CO₂ or C₃H₆. Plasticization of the polymer is exhibited by swelling of the membrane structure and by a significant increase in the permeances of all components in the feed and decrease of selectivity occurring above the plasticization pressure when the feed gas mixture contains condensable gases. Plasticization is particularly an issue for gas fields containing high CO₂ concentrations and for systems requiring two-stage membrane separation.

US 2005/0268783 A1 disclosed chemically cross-linked polyimide hollow fiber membranes prepared from a monoesterified polymer followed by final cross-linking after hollow fiber formation.

U.S. Pat. No. 7,485,173 disclosed UV cross-linked mixed matrix membranes via UV radiation. The cross-linked mixed matrix membranes comprise microporous materials dispersed in the continuous UV cross-linked polymer matrix.

The present invention discloses high performance cross-linked polyimide asymmetric flat sheet membranes and methods for making and using these membranes.

### SUMMARY OF THE INVENTION

This invention pertains to cross-linked polyimide asymmetric flat sheet membranes with high performance for gas separations and a process of using these membranes.

The present invention provides a high performance cross-linked polyimide asymmetric flat sheet membrane for gas separation. The cross-linked polyimide asymmetric flat sheet membrane comprises: a) a non-porous cross-linked polymer coating layer; b) a non-porous UV cross-linked polyimide selective layer; c) a porous polyimide non-selective asymmetric support layer; and d) a highly porous non-selective symmetric woven polymer fabric backing layer; wherein said polyimide in the non-porous UV cross-linked polyimide selective layer is the same as the polyimide in the porous polyimide non-selective asymmetric support layer and comprises a plurality of repeating units of formula (I)

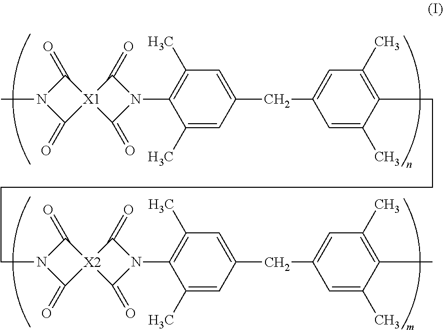

wherein X1 is selected from the group consisting of

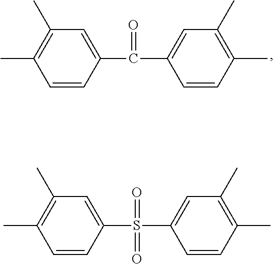

and mixtures thereof; wherein X2 is selected from the group consisting of

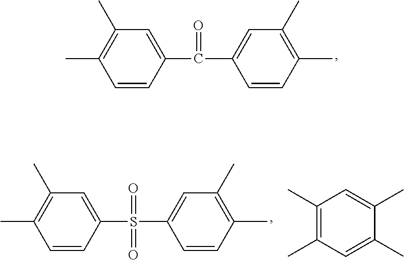

and mixtures thereof; wherein n and m are independent integers from 20 to 500; wherein said non-porous UV cross-linked polyimide selective layer and said porous polyimide non-selective asymmetric support layer are formed on said highly porous non-selective symmetric woven polymer fabric backing layer via a phase inversion process; wherein said highly porous non-selective symmetric woven polymer fabric backing layer has an air permeance of at least 6×10⁻³ cm³ (STP)/cm² s Pa at an air humidity of 18%.

The non-porous UV cross-linked polyimide selective layer of the cross-linked polyimide asymmetric flat sheet membrane described in the present invention comprises polyimide polymer chain segments where at least part of these polymer chain segments are cross-linked to each other through possible direct covalent bonds by exposure to UV radiation.

The high performance cross-linked polyimide asymmetric flat sheet membranes were prepared by an inversion casting process, then applying a non-porous cross-linked polymer coating layer, and finally applying UV radiation on the surface of the membrane.

One cross-linked polyimide asymmetric flat sheet membrane described in the present invention is fabricated from poly(3,3′,4,4′-diphenylsulfone tetracarboxylic dianhydride-3,3′,5,5′-tetramethyl-4,4′-methylene dianiline) (PI-1) which is derived from the condensation reaction of 3,3′,4,4′-diphenylsulfone tetracarboxylic dianhydride (DSDA) with 3,3′,5,5′-tetramethyl-4,4′-methylene dianiline (TMMDA). The membrane casting dope formula comprises PI-1, N-methylpyrrolidone (NMP), 1,3-dioxolane, and non-solvents. The cross-linked PI-1 membrane showed high CO₂/CH₄ separation performance with CO₂ permeance of 149 GPU and CO₂/CH₄ selectivity of 23 for CO₂/CH₄ separation.

Another cross-linked polyimide asymmetric flat sheet membrane described in the present invention is fabricated from poly(3,3′,4,4′-benzophenone tetracarboxylic dianhydride-pyromellitic dianhydride-3,3′,5,5′-tetramethyl-4,4′-methylene dianiline) (PI-2) derived from the condensation reaction of 3,3′,4,4′-benzophenone tetracarboxylic dianhydride (BTDA, 50 mol-%) and pyromellitic dianhydride (PMDA, 50 mol-%) with 3,3′,5,5′-tetramethyl-4,4′-methylene dianiline (TMMDA, 100 mol-%). The membrane casting dope formula comprises PI-2, NMP, 1,3-dioxolane, and non-solvents. The cross-linked PI-2 membrane showed high CO₂/CH₄ separation performance with CO₂ permeance of 160 GPU and CO₂/CH₄ selectivity of 23 for CO₂/CH₄ separation.

The invention provides a process for separating at least one gas from a mixture of gases using the cross-linked polyimide asymmetric flat sheet membrane described herein, the process comprising: (a) providing a cross-linked polyimide asymmetric flat sheet membrane described in the present invention which is permeable to said at least one gas; (b) contacting the mixture on one side of the cross-linked polyimide asymmetric flat sheet membrane to cause said at least one gas to permeate the membrane; and (c) removing from the opposite side of the membrane a permeate gas composition comprising a portion of said at least one gas which permeated said membrane.

The cross-linked polyimide asymmetric flat sheet membrane are not only suitable for a variety of liquid, gas, and vapor separations such as desalination of water by reverse osmosis, non-aqueous liquid separation such as deep desulfurization of gasoline and diesel fuels, ethanol/water separations, pervaporation dehydration of aqueous/organic mixtures, CO₂/CH₄, CO₂/N₂, H₂/CH₄, O₂/N₂, H₂S/CH₄, olefin/paraffin, iso/normal paraffins separations, and other light gas mixture separations, but also can be used for other applications such as for catalysis and fuel cell applications.

### DETAILED DESCRIPTION OF THE INVENTION

The use of membranes for separation of both gases and liquids is a growing technological area with potentially high economic reward due to the low energy requirements and the potential for scaling up of modular membrane designs. Advances in membrane technology, with the continuing development of new membrane materials and new methods for the production of high performance membranes will make this technology even more competitive with traditional, high-energy intensive and costly processes such as distillation. Among the applications for large scale gas separation membrane systems are nitrogen enrichment, oxygen enrichment, hydrogen recovery, removal of hydrogen sulfide and carbon dioxide from natural gas and dehydration of air and natural gas. Also, various hydrocarbon separations are potential applications for the appropriate membrane system. The membranes that are used in these applications must have high selectivity, durability, and productivity in processing large volumes of gas or liquid in order to be economically successful. Membranes for gas separations have evolved rapidly in the past 25 years due to their easy proccessability for scale-up and low energy requirements. More than 90% of the membrane gas separation applications involve the separation of noncondensable gases: such as carbon dioxide from methane, nitrogen from air, and hydrogen from nitrogen, argon or methane. Membrane gas separation is of special interest to petroleum producers and refiners, chemical companies, and industrial gas suppliers. Several applications of membrane gas separation have achieved commercial success, including nitrogen enrichment from air, carbon dioxide removal from natural gas and biogas and in enhanced oil recovery.

The present invention provides a cross-linked polyimide asymmetric flat sheet membrane. This invention also pertains to the application of the cross-linked polyimide asymmetric flat sheet membrane for a variety of gas separations such as separations of CO₂/CH₄, CO₂/N₂, olefin/paraffin separations (e.g. propylene/propane separation), H₂/CH₄, O₂/N₂, iso/normal paraffins, polar molecules such as H₂O, H₂S, and NH₃/mixtures with CH₄, N₂, H₂, and other light gases separations, as well as for liquid separations such as desalination and pervaporation.

The cross-linked polyimide asymmetric flat sheet membrane in the present invention comprises: a) a non-porous cross-linked polymer coating layer; b) a non-porous UV cross-linked polyimide selective layer; c) a porous polyimide non-selective asymmetric support layer; and d) a highly porous non-selective symmetric woven polymer fabric backing layer; wherein said polyimide in the non-porous UV cross-linked polyimide selective layer is the same as said polyimide in the porous polyimide non-selective asymmetric support layer and comprises a plurality of repeating units of formula (I)

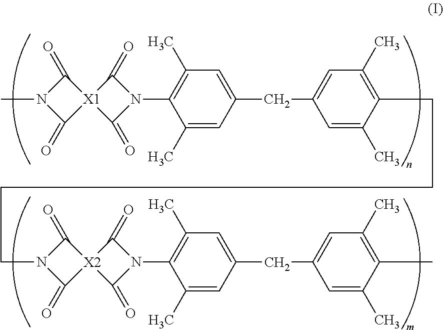

wherein X1 is selected from the group consisting of

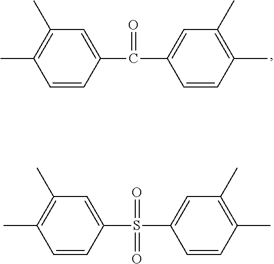

and mixtures thereof; wherein X2 is selected from the group consisting of

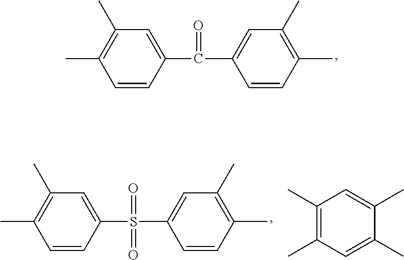

and mixtures thereof; wherein n and m are independent integers from 20 to 500; wherein said non-porous UV cross-linked polyimide selective layer and said porous polyimide non-selective asymmetric support layer are formed on said highly porous non-selective symmetric woven polymer fabric backing layer via phase inversion process; wherein said highly porous non-selective symmetric woven polymer fabric backing layer has an air permeance of at least 6×10⁻³ cm³ (STP)/cm² s Pa at an air humidity of 18%.

Some of the preferred polyimide polymers that are used for the formation of the non-porous UV cross-linked polyimide selective layer and the porous polyimide non-selective asymmetric support layer in the present invention include, but are not limited to, poly(3,3′,4,4′-diphenylsulfone tetracarboxylic dianhydride-3,3′,5,5′-tetramethyl-4,4′-methylene dianiline) derived from the condensation reaction of 3,3′,4,4′-diphenylsulfone tetracarboxylic dianhydride (DSDA) and 3,3′,5,5′-tetramethyl-4,4′-methylene dianiline (TMMDA), referred to as PI-1; poly(3,3′,4,4′-benzophenone tetracarboxylic dianhydride-pyromellitic dianhydride-3,3′,5,5′-tetramethyl-4,4′-methylene dianiline) derived from the condensation reaction of 3,3′,4,4′-benzophenone tetracarboxylic dianhydride (BTDA, 50 mol-%) and pyromellitic dianhydride (PMDA, 50 mol-%) with TMMDA (100 mol-%), referred to as PI-2; and poly(3,3′,4,4′-diphenylsulfone tetracarboxylic dianhydride-pyromellitic dianhydride-3,3′,5,5′-tetramethyl-4,4′-methylene dianiline) derived from the condensation reaction of DSDA (80 mol-%) and PMDA (20 mol-%) with TMMDA (100 mol-%), referred to as PI-3.

The polymer used to form the non-porous cross-linked polymer coating layer described in the current invention may be selected from, but are not limited to, polysiloxane, fluoro-polymer, thermally cross-linkable silicone rubber, UV radiation cross-linkable epoxy silicone, or mixtures thereof.

The polymer used to form the highly porous non-selective symmetric woven polymer fabric backing layer described in the current invention may be selected from, but are not limited to, Nylon 6, Nylon 6,6, Nylon 6,10, Nylon 6,12, Nylon 10,10, Nylon 10, 12, polyester, polyimide, and fluoropolymer.

The non-porous UV cross-linked polyimide selective layer of the cross-linked polyimide asymmetric flat sheet membrane described in the present invention comprises polyimide polymer chain segments where at least part of these polymer chain segments are cross-linked to each other through possible direct covalent bonds by exposure to UV radiation. The thickness of the non-porous UV cross-linked polyimide selective layer of the cross-linked polyimide asymmetric flat sheet membrane described in the present invention is in a range of 5-500 nm.

The casting dope formula for the preparation of cross-linked polyimide asymmetric flat sheet membrane described in the present invention comprises good solvents for the polyimide polymer such as NMP and 1,3-dioxolane, non-solvents for the polyimide polymer such as methanol, ethanol, iso-propanol, glycerol, acetone, n-octane, and lactic acid. The invention provides a process for separating at least one gas from a mixture of gases using the new high performance cross-linked polyimide asymmetric flat sheet membrane described in the present invention, the process comprising: (a) providing a cross-linked polyimide asymmetric flat sheet membrane described in the present invention which is permeable to said at least one gas; (b) contacting the mixture on one side of the cross-linked polyimide asymmetric flat sheet membrane described in the present invention to cause said at least one gas to permeate the membrane; and (c) removing from the opposite side of the membrane a permeate gas composition comprising a portion of said at least one gas which permeated said membrane.

The cross-linked polyimide asymmetric flat sheet membrane described in the present invention is especially useful in the purification, separation or adsorption of a particular species in the liquid or gas phase. In addition to separation of pairs of gases, the cross-linked polyimide asymmetric flat sheet membrane described in the present invention may, for example, be used for the desalination of water by reverse osmosis or for the separation of proteins or other thermally unstable compounds, e.g. in the pharmaceutical and biotechnology industries. The cross-linked polyimide asymmetric flat sheet membrane described in the present invention may also be used in fermenters and bioreactors to transport gases into the reaction vessel and transfer cell culture medium out of the vessel. Additionally, the cross-linked polyimide asymmetric flat sheet membrane described in the present invention may be used for the removal of microorganisms from air or water streams, water purification, ethanol production in a continuous fermentation/membrane pervaporation system, and in detection or removal of trace compounds or metal salts in air or water streams.

The cross-linked polyimide asymmetric flat sheet membrane described in the present invention is especially useful in gas separation processes in air purification, petrochemical, refinery, and natural gas industries. Examples of such separations include separation of volatile organic compounds (such as toluene, xylene, and acetone) from an atmospheric gas, such as nitrogen or oxygen and nitrogen recovery from air. Further examples of such separations are for the separation of CO₂ or H₂S from natural gas, H₂ from N₂, CH₄, and Ar in ammonia purge gas streams, H₂ recovery in refineries, olefin/paraffin separations such as propylene/propane separation, and iso/normal paraffin separations. Any given pair or group of gases that differ in molecular size, for example nitrogen and oxygen, carbon dioxide and methane, hydrogen and methane or carbon monoxide, helium and methane, can be separated using the cross-linked polyimide asymmetric flat sheet membrane described in the present invention. More than two gases can be removed from a third gas. For example, some of the gas components which can be selectively removed from a raw natural gas using the membrane described herein include carbon dioxide, oxygen, nitrogen, water vapor, hydrogen sulfide, helium, and other trace gases. Some of the gas components that can be selectively retained include hydrocarbon gases. When permeable components are acid components selected from the group consisting of carbon dioxide, hydrogen sulfide, and mixtures thereof and are removed from a hydrocarbon mixture such as natural gas, one module, or at least two in parallel service, or a series of modules may be utilized to remove the acid components. For example, when one module is utilized, the pressure of the feed gas may vary from 275 kPa to about 2.6 MPa (25 to 4000 psi). The differential pressure across the membrane can be as low as about 70 kPa or as high as 14.5 MPa (about 10 psi or as high as about 2100 psi) depending on many factors such as the particular membrane used, the flow rate of the inlet stream and the availability of a compressor to compress the permeate stream if such compression is desired. Differential pressure greater than about 14.5 MPa (2100 psi) may rupture the membrane. A differential pressure of at least 0.7 MPa (100 psi) is preferred since lower differential pressures may require more modules, more time and compression of intermediate product streams. The operating temperature of the process may vary depending upon the temperature of the feed stream and upon ambient temperature conditions. Preferably, the effective operating temperature of the membranes of the present invention will range from about −50° to about 150° C. More preferably, the effective operating temperature of the cross-linked polyimide asymmetric flat sheet membrane of the present invention will range from about −20° to about 100° C., and most preferably, the effective operating temperature of the membranes of the present invention will range from about 25° to about 100° C.

The cross-linked polyimide asymmetric flat sheet membrane described in the present invention are also especially useful in gas/vapor separation processes in chemical, petrochemical, pharmaceutical and allied industries for removing organic vapors from gas streams, e.g. in off-gas treatment for recovery of volatile organic compounds to meet clean air regulations, or within process streams in production plants so that valuable compounds (e.g., vinylchloride monomer, propylene) may be recovered. Further examples of gas/vapor separation processes in which the cross-linked polyimide asymmetric flat sheet membrane described in the present invention may be used are hydrocarbon vapor separation from hydrogen in oil and gas refineries, for hydrocarbon dew pointing of natural gas (i.e. to decrease the hydrocarbon dew point to below the lowest possible export pipeline temperature so that liquid hydrocarbons do not separate in the pipeline), for control of methane number in fuel gas for gas engines and gas turbines, and for gasoline recovery. The cross-linked polyimide asymmetric flat sheet membrane described in the present invention may incorporate a species that adsorbs strongly to certain gases (e.g. cobalt porphyrins or phthalocyanines for O₂ or silver (I) for ethane) to facilitate their transport across the membrane.

The cross-linked polyimide asymmetric flat sheet membrane described in the present invention also has immediate application to concentrate olefin in a paraffin/olefin stream for olefin cracking application. For example, the cross-linked polyimide asymmetric flat sheet membrane described in the present invention can be used for propylene/propane separation to increase the concentration of the effluent in a catalytic dehydrogenation reaction for the production of propylene from propane and isobutylene from isobutane. Therefore, the number of stages of a propylene/propane splitter that is required to get polymer grade propylene can be reduced. Another application for the cross-linked polyimide asymmetric flat sheet membrane described in the present invention is for separating isoparaffin and normal paraffin in light paraffin isomerization and MaxEne™, a process for enhancing the concentration of normal paraffin (n-paraffin) in the naphtha cracker feedstock, which can be then converted to ethylene.

The cross-linked polyimide asymmetric flat sheet membrane described in the present invention can also be operated at high temperature to provide the sufficient dew point margin for natural gas upgrading (e.g, CO₂ removal from natural gas). The cross-linked polyimide asymmetric flat sheet membrane described in the present invention can be used in either a single stage membrane or as the first or/and second stage membrane in a two stage membrane system for natural gas upgrading.

The cross-linked polyimide asymmetric flat sheet membrane described in the present invention may also be used in the separation of liquid mixtures by pervaporation, such as in the removal of organic compounds (e. g., alcohols, phenols, chlorinated hydrocarbons, pyridines, ketones) from water such as aqueous effluents or process fluids. A membrane which is ethanol-selective would be used to increase the ethanol concentration in relatively dilute ethanol solutions (5-10% ethanol) obtained by fermentation processes. Another liquid phase separation example using the cross-linked polyimide asymmetric flat sheet membrane described in the present invention is the deep desulfurization of gasoline and diesel fuels by a pervaporation membrane process similar to the process described in U.S. Pat. No. 7,048,846, incorporated by reference herein in its entirety. The cross-linked polyimide asymmetric flat sheet membrane described in the present invention that are selective to sulfur-containing molecules would be used to selectively remove sulfur-containing molecules from fluid catalytic cracking (FCC) and other naphtha hydrocarbon streams. Further liquid phase examples include the separation of one organic component from another organic component, e.g. to separate isomers of organic compounds. Mixtures of organic compounds which may be separated using the cross-linked polyimide asymmetric flat sheet membrane described in the present invention include: ethylacetate-ethanol, diethylether-ethanol, acetic acid-ethanol, benzene-ethanol, chloroform-ethanol, chloroform-methanol, acetone-isopropylether, allylalcohol-allylether, allylalcohol-cyclohexane, butanol-butylacetate, butanol-1-butylether, ethanol-ethylbutylether, propylacetate-propanol, isopropylether-isopropanol, methanol-ethanol-isopropanol, and ethylacetate-ethanol-acetic acid.

### EXAMPLES

The following examples are provided to illustrate one or more preferred embodiments of the invention, but are not limited embodiments thereof. Numerous variations can be made to the following examples that lie within the scope of the invention.

### Example 1

### Preparation of UV Cross-Linked PI-1 Asymmetric Flat Sheet Membrane (Abbreviated as XM-PI-1)

A PI-1 polyimide casting dope containing PI-1, NMP, 1,3-dioxolane, and non-solvents was cast on a highly porous non-selective symmetric woven Nylon 6,6 fabric backing at a casting speed of 6 fpm at room temperature. The cast membrane was evaporated for 13 seconds to form the nascent polyimide membrane with a thin dense selective skin layer on the surface. The membrane was immersed into a water coagulation tank at 0-2° C. to generate the porous polyimide non-selective asymmetric support layer below the thin dense selective skin layer by phase inversion. The wet membrane was then immersed into a hot water tank at 85° C. to remove the trace amount of organic solvents in the membrane. Finally the wet membrane was wound up on a core roll for further drying. The wet polyimide membrane was dried at 70° C. The thin dense selective skin layer surface of the dried polyimide membrane was then coated with a thin non-porous layer of thermally cross-linked silicone rubber. The thin dense selective skin layer surface of the coated polyimide membrane was further cross-linked via UV radiation for 10 min using a UV lamp with intensity of 1.45 mW/cm² without cross-linking of the porous polyimide non-selective asymmetric support layer below the thin dense selective skin layer.

### Example 2

### Preparation of UV Cross-Linked PI-2 Asymmetric Flat Sheet Membrane (Abbreviated as XM-PI-2)

A PI-2 polyimide casting dope containing PI-2, NMP, 1,3-dioxolane, and non-solvents was cast on a highly porous non-selective symmetric woven Nylon 6,6 fabric backing at a casting speed of 6 fpm at room temperature. The cast membrane was evaporated for 13 seconds to form the nascent polyimide membrane with a thin dense selective skin layer on the surface. The membrane was immersed into a water coagulation tank at 0-2° C. to generate the porous polyimide non-selective asymmetric support layer below the thin dense selective skin layer by phase inversion. The wet membrane was then immersed into a hot water tank at 85° C. to remove the trace amount of organic solvents in the membrane. Finally the wet membrane was wound up on a core roll for further drying. The wet polyimide membrane was dried at 70° C. The thin dense selective skin layer surface of the dried polyimide membrane was then coated with a thin non-porous layer of thermally cross-linked silicone rubber. The thin dense selective skin layer surface of the coated polyimide membrane was further cross-linked via UV radiation for 13 min using a UV lamp with intensity of 1.25 mW/cm² without cross-linking of the porous polyimide non-selective asymmetric support layer below the thin dense selective skin layer.

### Example 3

### Evaluation of CO₂/CH₄ Separation Performance of XM-PI-1 and XM-PI-2

The XM-PI-1 and XM-PI-2 membranes were tested for CO₂/CH₄ separation at 50° C. under 6996 kPa (1000 psig) feed gas pressure with 10% of CO₂ and 90% of CH₄ in the feed. The results are shown in the following Table. It can be seen from the Table that both membranes described in the current invention showed CO₂ permeances of over 140 GPU and CO₂/CH₄ selectivities over 20.

TABLE
CO₂/CH₄ separation performance of XM-PI-1 and XM-PI-2 membranes

| Membrane | CO₂ permeance (GPU) | CO₂/CH₄ selectivity |
|---|---|---|
| XM-PI-1 | 149 | 22.9 |
| XM-PI-2 | 160 | 23.0 |

1 GPU = 10⁻⁶ cm³ (STP)/cm² s (cm Hg)Testing conditions: 50° C., 6996 kPa (1000 psig) feed gas pressure, 10% CO₂ and 90% of CH₄ in the feed.

1. A cross-linked polyimide asymmetric flat sheet membrane comprising a non-porous cross-linked polymer coating layer, a non-porous UV cross-linked polyimide selective layer, a porous polyimide non-selective asymmetric support layer, and a highly porous non-selective symmetric woven polymer fabric backing layer; wherein said polyimide in the non-porous UV cross-linked polyimide selective layer is the same polymer as said polyimide in the porous polyimide non-selective asymmetric support layer and comprises a plurality of repeating units of formula (I) 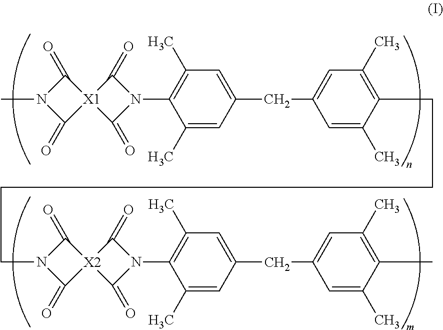
wherein X1 is selected from the group consisting of 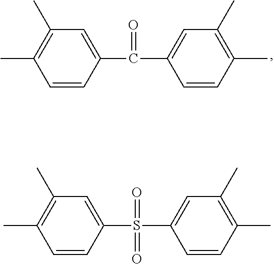
and mixtures thereof and wherein X2 is selected from the group consisting of 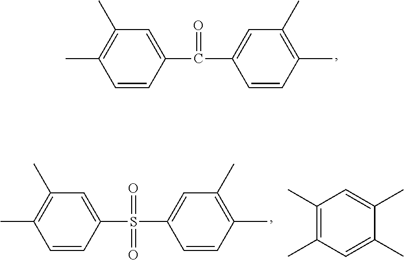
and mixtures thereof.

2. The membrane of claim 1 wherein said highly porous non-selective symmetric woven polymer fabric backing layer has an air permeance of at least 6×10⁻³ cm³(STP)/cm² s Pa at an air humidity of 18%.

3. The membrane of claim 1 wherein said polyimide comprises poly(3,3′,4,4′-diphenylsulfone tetracarboxylic dianhydride-3,3′,5,5′-tetramethyl-4,4′-methylene dianiline).

4. The membrane of claim 1 wherein said polyimide comprises poly(3,3′,4,4′-benzophenone tetracarboxylic dianhydride-pyromellitic dianhydride-3,3′,5,5′-tetramethyl-4,4′-methylene dianiline).

5. The membrane of claim 1 wherein m is an integer from 20 to 500.

6. The membrane of claim 1 wherein n is an integer from 20 to 500.

7. A process for separating at least one fluid or gas from a mixture of fluids or gases using a cross-linked polyimide asymmetric flat sheet membrane, the process comprising:
(a) providing a cross-linked polyimide asymmetric flat sheet membrane comprising a non-porous cross-linked polymer coating layer, a non-porous UV cross-linked polyimide selective layer, a porous polyimide non-selective asymmetric support layer, and a highly porous non-selective symmetric woven polymer fabric backing layer; wherein said polyimide in the non-porous UV cross-linked polyimide selective layer is the same polymer as said polyimide in the porous polyimide non-selective asymmetric support layer and comprises a plurality of repeating units of formula (I) 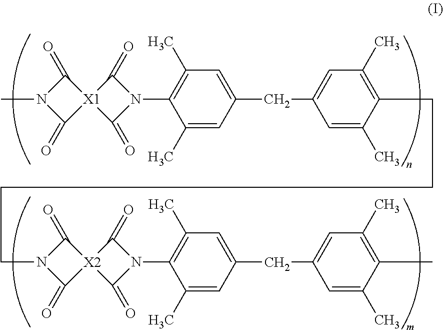
wherein X1 is selected from the group consisting of 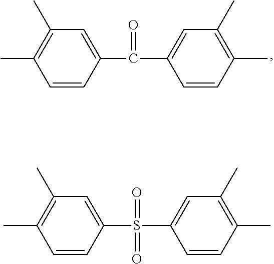
and mixtures thereof; and wherein X2 is selected from the group consisting of 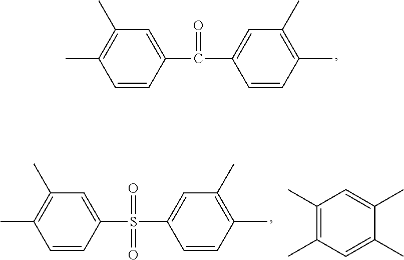
and mixtures thereof which is permeable to said at least one gas;
(b) contacting the mixture on one side of the cross-linked polyimide asymmetric flat sheet membrane to cause said at least one gas to permeate the membrane; and
(c) removing from the opposite side of the membrane a permeate gas composition comprising a portion of said at least one gas which permeated said membrane.

8. The process of claim 7 wherein said fluids or gases comprise atmospheric gases comprising at least one volatile organic compound and said process separates at least one volatile organic compound from said atmospheric gases.

9. The process of claim 7 wherein said fluids or gases comprise natural gas and said process separates carbon dioxide or hydrogen sulfide from said natural gas.

10. The process of claim 7 wherein said fluids or gases comprise air and said process separates nitrogen or oxygen from said air.

11. The process of claim 7 wherein said fluids or gases comprise a mixture of hydrogen, nitrogen, methane and argon in an ammonia purge stream and said process separates hydrogen from said mixture.

12. The process of claim 7 wherein said process separates hydrogen from a refinery stream.

13. The process of claim 7 wherein said process separates propylene from propane.

14. The process of claim 7 wherein said process separates iso and normal paraffins.

15. The process of claim 7 wherein said process separates nitrogen from oxygen, hydrogen from methane, carbon monoxide or helium from methane.

16. The process of claim 7 wherein separates at least one or more gas components selected from the group consisting of carbon dioxide, oxygen, nitrogen, water vapor, hydrogen sulfide and helium from natural gas.

17. The process of claim 7 wherein said process separates a mixture of organic chemicals selected from the group consisting of ethylacetate-ethanol, diethylether-ethanol, acetic acid-ethanol, benzene-ethanol, chloroform-ethanol, chloroform-methanol, acetone-isopropylether, allylalcohol-allylether, allylalcohol-cyclohexane, butanol-butylacetate, butanol-1-butylether, ethanol-ethylbutylether, propylacetate-propanol, isopropylether-isopropanol, methanol-ethanol-isopropanol, and ethylacetate-ethanol-acetic acid.

18. The process of claim 7 wherein said process separates a mixture of organic isomers.

19. The process of claim 7 wherein said process separates a mixture of liquids by a pervaporation process.

20. The process of claim 7 wherein said process increases the concentration of an effluent in catalytic dehydrogenation reactions for production of propylene from propane and isobutylene from isobutane.
